(19) United States
(12) Patent Application Publication
(10) Pub. No.: US 2026/0221885 A1
(43) Pub. Date: Jul. 30, 2026

(54) CAPACITOR CHARGING METHOD OF A HIGH VOLTAGE NETWORK FROM A LOW VOLTAGE POWER SOURCE

(71) Applicant: Eaton Intelligent Power Limited, Dublin 4 (IE)

(72) Inventor: Claude BOURGEAT, Violay (FR)

(21) Appl. No.: 19/147,627

(22) PCT Filed: Jan. 11, 2024
(86) PCT No.: PCT/EP2024/025017

§ 371 Date: Jul. 11, 2025

Related U.S. Application Data
(60) Provisional application No. 63/438,869, filed on Jan. 13, 2023.

(51) Int. Cl. H02M 3/335; B60L 50/40; H02M 1/00

(52) U.S. Cl. CPC H02M 3/33573; H02M 1/0048; H02M 3/33576; B60L 50/40; B60L 2210/12; B60L 2210/14; H02M 1/0043

(57) ABSTRACT

A capacitor charging method of a high voltage network from a low voltage power source can be accomplished without wasting energy stored in the output inductor LI of a DC-to-DC converter by recovering the energy in a capacitor of a demagnetization circuit integrated with the DC-to-DC converter and transferring this energy to the low voltage network for use in recharging capacitors at the high voltage network. The method includes three stages: a buck mode where the demagnetization circuit is operated; a first boost mode where the capacitor of the high voltage network is charged to a maximum input current and the demagnetization circuit is disabled; and a second boost mode where the capacitor of the high voltage network is charged to a maximum power of the converter until a voltage of the high voltage network is achieved.

### BACKGROUND

DC-to-DC converters are used in automotive applications to supply systems of different voltage levels throughout a vehicle. A common automotive application is to enable DC power from a high voltage battery to be used to supply lower DC voltages that power components such as headlights, interior lights, motorized windows, etc.

For example, a DC-to-DC converter is used in electric or hybrid vehicles, where a high voltage (HV) network having capacitors and a battery of several hundred volts (e.g., 400V or 800V) is used to provide energy to the electric motor, and a low voltage (LV) network having a Battery (e.g., 12V, 24V or 48V) is used to supply the control and comfort equipment of the vehicle. Such a DC-to-DC converter is typically inserted between the two HV and LV batteries with galvanic isolation for safety reasons and is used to transform and transfer the energy from the HV battery to the LV battery when the vehicle is running.

The HV battery is charged when the vehicle is stationary by using a charging station, which may be at home or with a parking space in town centers, shopping centers, etc.

FIG. 1 illustrates a conventional configuration for a vehicle application of a DC-to-DC converter 100. Referring to FIG. 1, when an electric vehicle is running, the DC-to-DC converter 100 transforms and transfers the energy one way from the HV battery 102 to the LV battery 104 through output inductor L1. That is, the conventional DC-to-DC converter provides one way energy transfer. When the electric vehicle is stationary, the HV battery 102 is disconnected, using switches 106, from the entire high voltage network for safety reasons. Thus, all the high voltage capacitors 108 (collectively referenced in the figure as Chv) on the high voltage network are at zero volts when the vehicle is stationary. Therefore, before each start of the vehicle, to provide energy to the electric motor 110 through inverter 112, the HV battery 102 must be reconnected to the whole of the high voltage networks. However, properly reconnecting the HV battery 102 (e.g., via switches 106) is only possible if the high voltage capacitors 108 of the HV network are charged at the same voltage as the HV battery 102. In the prior art, as shown in FIG. 1 the charge of the high voltage capacitors 108 (Chv) using the HV battery 102 is done with a switch 114 and a resistor 116. However, due to the current through the switch 114 and the voltage across the switch 114, the time and effort of charging the high voltage capacitors 108 has to account for the power loss/energy dissipation (e.g., as heat).

### BRIEF SUMMARY

Capacitor charging method of a high voltage network from a low voltage power source is provided. Through certain implementations of the described circuitry and methods, it is possible to improve energy efficiency of the charging of the high voltage capacitors.

Capacitor charging method of a high voltage network from a low voltage power source can be accomplished using a modified DC-to-DC converter without wasting energy stored in the output inductor L1 of the DC-to-DC converter by recovering the energy of the output inductor L1 in a capacitor of a demagnetization circuit integrated with the DC-to-DC converter and transferring this energy to the low voltage network for use in recharging capacitors at the high voltage network. The method includes three stages: a buck mode where the demagnetization circuit is operated; a first boost mode where the capacitor of the high voltage network is charged to a maximum input current and the demagnetization circuit is disabled; and a second boost mode where the capacitor of the high voltage network is charged to a maximum power of the converter until a voltage of the high voltage network is achieved.

A controller is provided with instructions that when executed direct operations of a DC-to-DC converter with an integrated capacitor charging function, including operating, by the controller, the DC-to-DC converter in a buck mode; switching, by the controller, from the buck mode to a first boost mode; operating, by the controller, the DC-to-DC converter in the first boost mode, wherein during the first boost mode, the capacitor of the high voltage network is charged to a maximum input current and the demagnetization circuit is disabled; and operating, by the controller, the DC-to-DC converter in a second boost mode, wherein during the second boost mode, the capacitor of the high voltage network is charged to a maximum power of the converter until a voltage of the high voltage network is achieved.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

FIG. 1 illustrates a conventional configuration for a vehicle application of a DC-to-DC converter.

FIG. 2 illustrates a configuration operation for a vehicle application of a DC-to-DC converter with an integrated capacitor charging function as described herein.

FIG. 3 is a schematic diagram of an example implementation of DC-to-DC converter with the integrated capacitor charging function.

FIGS. 4A and 4B illustrate a method and charging strategy of a high voltage capacitor of a high-side of a DC-to-DC converter application.

FIG. 5 illustrates a timing diagram for buck mode in accordance with one embodiment.

FIG. 6 illustrates a timing diagram for boost mode in accordance with one embodiment.

FIG. 7 shows a process flow diagram of example control logic for carrying out charging of the high voltage capacitor.

### DETAILED DESCRIPTION

Capacitor charging method of a high voltage network from a low voltage power source is provided. Through certain implementations of the described circuitry and methods, it is possible to improve energy efficiency of the charging of the high voltage capacitors.

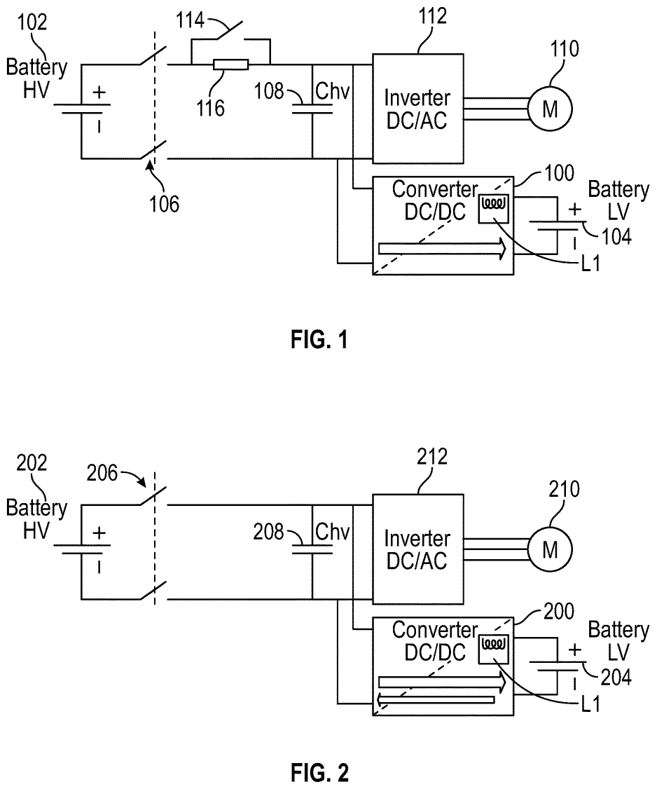

By using a DC-to-DC converter with an integrated capacitor charging function as illustrated herein, it is possible to eliminate the charging arrangement using switch 114 and resistor 116 for charging the high voltage capacitors 108 as shown in the configuration of FIG. 1. Eliminating the charging arrangement shown in FIG. 1 through certain implementations described herein can improve economic cost, reliability, and energy efficiency.

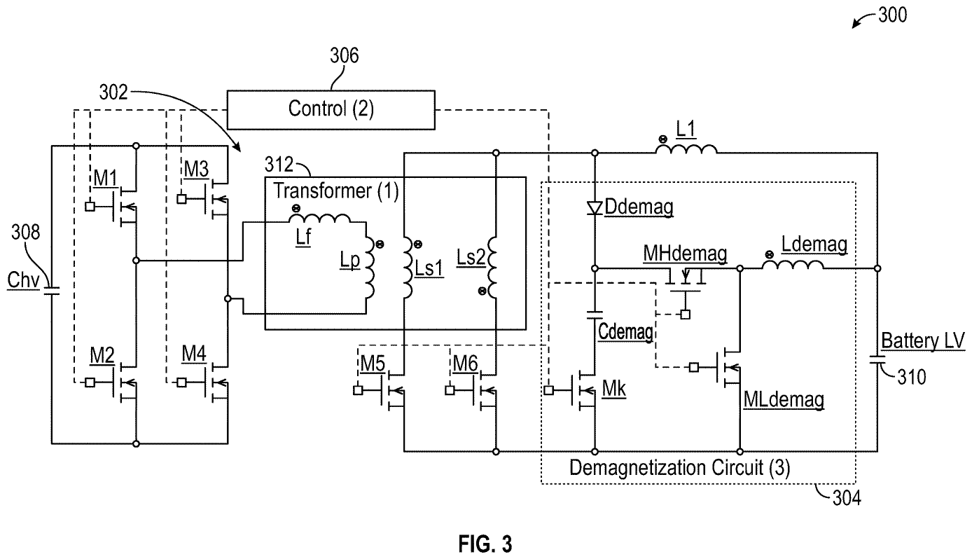

FIG. 2 illustrates a configuration operation for a vehicle application of a DC-to-DC converter 200 with an integrated capacitor charging function as described herein. Referring to FIG. 2, the DC-to-DC converter 200 supports a two way operation such that the energy of the LV battery 204 (including energy of the output inductor L1) can be used to charge the high voltage capacitors 208 in order to allow the connection of the HV battery 202 to the high voltage network (e.g., including the high voltage capacitors 108). In particular, similar to the configuration of FIG. 1, when an electric vehicle is running, the DC-to-DC converter 200 with integrated capacitor charging function transforms and transfers the energy from the HV battery 202 to the LV battery 204; and, when the electric vehicle is stationary, the HV battery 202 is disconnected via switches 206. However, unlike the configuration of FIG. 1, before the start of the vehicle, to provide energy to the electric motor 210 through inverter 212, the HV battery 202 is reconnected via switches 206 and the high voltage capacitors 208 are charged by the LV battery 204 using the DC-to-DC converter 200 with integrated capacitor charging function. The two-way functionality of the DC-to-DC converter 200 eliminates the need of the resistor 116 and switch 118 shown in the configuration of FIG. 1.

It should be understood that, as used herein, “high” voltage and “low” voltage are relative values such that components on the “high” side of the DC-to-DC converter are structured to operate at a relatively higher voltage than components on the “low” side of the DC-to-DC converter. Thus, when “high” is used, this term refers to a value that is higher than the “low” value and may be an order of magnitude higher than the “low” value (e.g., low is ~10\hat{ }1 while high is ~10\hat{ }2).

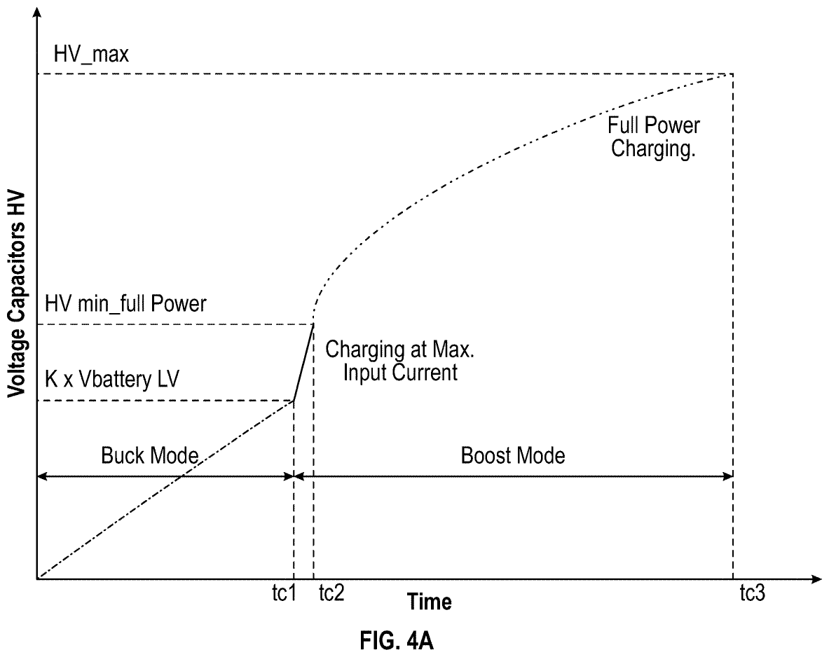

FIG. 3 is a schematic diagram of an example implementation of DC-to-DC converter with the integrated capacitor charging function. Referring to FIG. 3, converter 300 is an example implementation of DC-to-DC converter 200. Converter 300 includes a DC-to-DC converter circuit 302 and a demagnetization circuit 304. A controller 306 can be integrated with the converter 300 or be a separate component from the converter 300. The controller 306 can be implemented using one or more processors (executing suitable software instructions), state machines, and/or logic circuits.

The DC-to-DC converter circuit 302 includes a transformer 312, an inductor L1, and switches M1, M2, M3, M4, M5, and M6. The switches can be semiconductor switches. This structure alone does not allow the high voltage capacitor 308 to be charged on the HV side from zero volts because the inductor L1 cannot be demagnetized without heat dissipation.

The demagnetization circuit 304 includes a demagnetization capacitor Cdemag, a demagnetization inductor Ldemag, a demagnetization diode Ddemag, and switches Mk, MHdemag, and MLdemag. The Ldemag inductor is coupled at a first end to a first node at a first end of L1, which is coupled to a positive line of a low voltage capacitor and coupled at a second end to a second node. The MLdemag switch is coupled at its drain to the second node at the second end of Ldemag inductor and is coupled at its source to a ground line of the low voltage capacitor. The Ddemag is coupled at one end to a second end of L1 and is coupled at another end to a third node coupled to a first end of the Cdemag capacitor. The MHdemag switch is coupled at its source to the second node at the second end of the Ldemag inductor and is coupled at its source to the third node coupled to the first end of the Cdemag capacitor. The Mk switch is coupled at its drain to a second end of the Cdemag capacitor and is coupled at its source to the ground line of the low voltage capacitor.

The addition of the demagnetization circuit 304 enables the efficient demagnetization of inductor L1.

In FIG. 3, the demagnetization circuit 304 is shown coupled to a DC-to-DC converter circuit 302 implemented with a transformer 312 in the form of a full bridge on the high voltage side and a half bridge on the low voltage side. However, it should be understood that the illustrated demagnetization circuit 304 and methods described herein can be used with other DC-to-DC converter circuit configurations. Indeed, the demagnetization circuit 304 is able to provide integrated capacitor charging function with a variety of different DC-to-DC converter circuits, including, but not limited to, the half-bridge full-bridge converter, a phase shift converter such as a phase-shifted bridge converter (FBPS), and a Push-Pull converter. In addition, the DC-to-DC converter circuit 302 may be single phase or multi phase.

The purpose of the demagnetization circuit 304 combined with the DC-to-DC converter circuit 302 is to be able to use the LV battery 310 to charge the high voltage capacitor (Chv) 308 from zero volts to a desired voltage of the high voltage network (e.g., the voltage of the HV battery 202 shown in FIG. 2) in order to connect the HV battery to the network. This improvement makes it possible to charge the high voltage capacitor Chv 308 without waste (e.g., energy loss) and therefore to improve the energy balance of the vehicle.

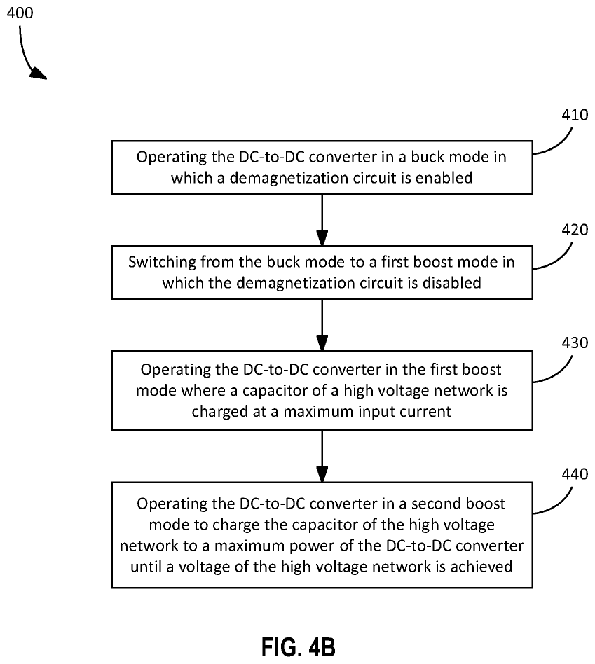

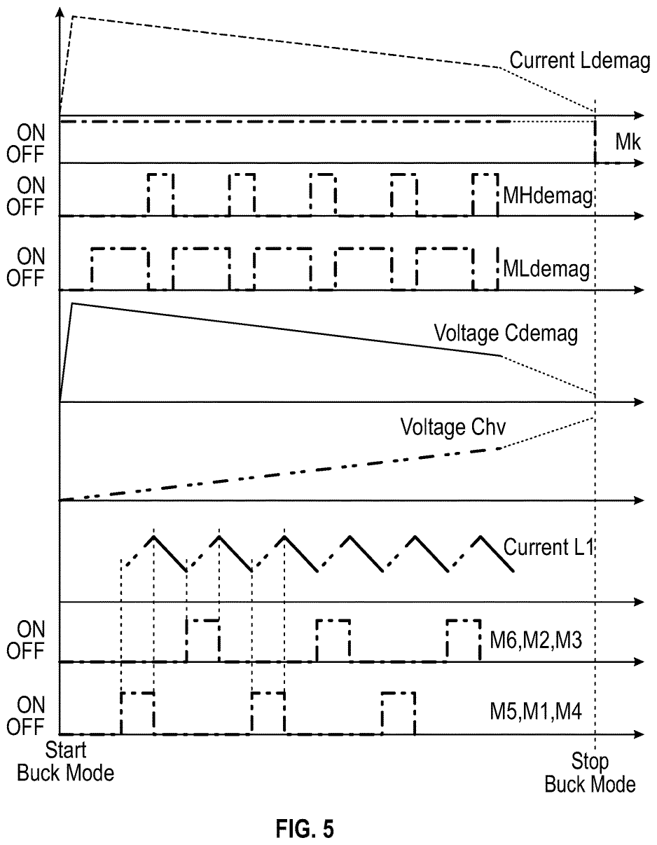

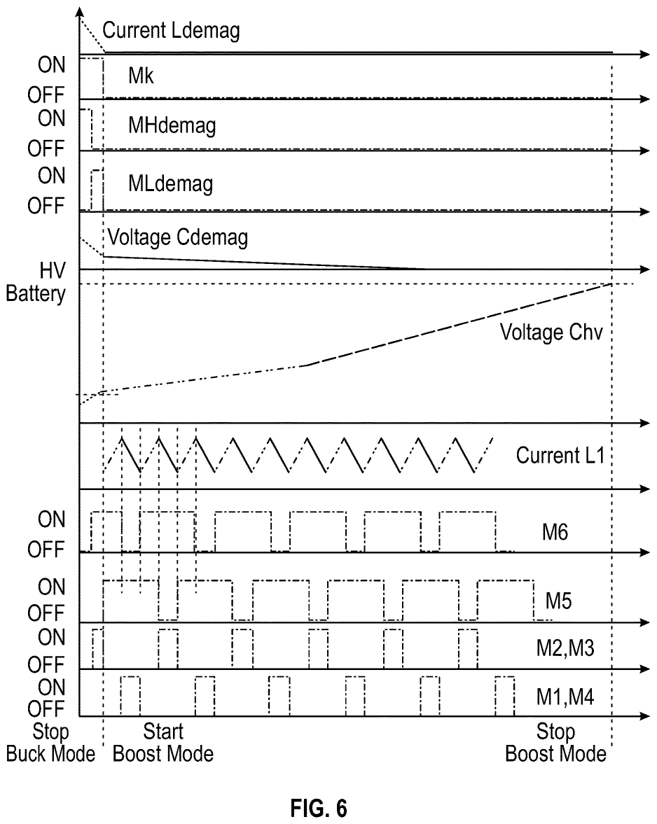

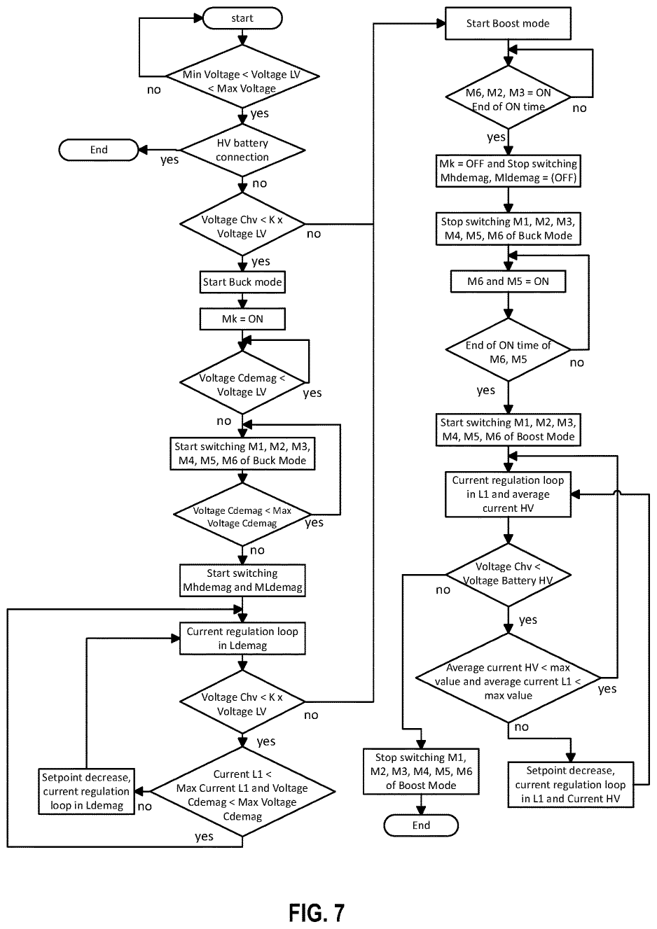

The charging process of capacitor Chv 308 is performed under control of controller 306, which operates switches M1, M2, M3, M4, M5, M6, Mk, MHdemag, and MLdemag. Through operations of the controller 306, the high voltage capacitor 308 can be charged as described with respect to FIGS. 4A and 4B. Example timing diagrams of control signals of operations of controller 306 in carrying out the method shown in FIG. 4B are shown and described with respect to FIG. 5, FIG. 6, and FIG. 7.

FIGS. 4A and 4B illustrate a method and charging strategy of a high voltage capacitor of a high-side of a DC-to-DC converter application. As previously noted, although reference is to a single capacitor, it should be understood that the single capacitor is a representation of a collection of capacitors and should be interpreted as one or more high voltage capacitors. Referring to FIG. 4A, the high voltage capacitor (e.g., Chv 308) is charged in three stages:
1: Buck mode, where Mk switch (ON), the demagnetization function is active, the magnetization energy of L1 is transferred to the LV battery.
2: Boost mode, where Mk switch (OFF), the demagnetization function is disabled, Chv capacitor is charged to the maximum input current.
3: Boost mode, where Mk switch (OFF), the demagnetization function is deactivated, Capacitor Chv is charged to the maximum power of the converter, up to the voltage of the high voltage network.

Referring to FIG. 4B, a controller performing operations for charging the high voltage capacitor (e.g., Chv 308) can perform a method 400 for charging a capacitor of a high voltage network from a low voltage power source using a DC-to-DC converter with an integrated capacitor charging function comprising a demagnetization circuit and a controller. Method 400 includes operating (410), by the controller, the DC-to-DC converter in a buck mode in which the demagnetization circuit is enabled; switching (420), by the controller, from the buck mode to a first boost mode in which the demagnetization circuit is disabled; operating (430), by the controller, the DC-to-DC converter in the first boost mode, wherein during the first boost mode, the capacitor of the high voltage network is charged at a maximum input current and the demagnetization circuit is disabled; and operating (440), by the controller, the DC-to-DC converter in a second boost mode, wherein during the second boost mode, the capacitor of the high voltage network is charged to a maximum power of the converter until a voltage of the high voltage network is achieved.

For each step, the controller 306 transmits the control orders for all the switches M1, M2, M3, M4, M5, M6, Mk, MHdemag, and MLdemag. Each switch is controlled to be in the on state (ON) or in the blocked state (OFF) described according to the timing diagrams in FIG. 5 and FIG. 6 so that the voltage and the current at the terminals of the transformer (e.g., transformer 312) is alternating and that the current and the voltage at the terminals of the inductor L1 are controlled so as not to endanger all the converter components.

In detail, during operation 410 for buck mode (stage 1), the voltage of capacitor Chv is charged from zero volts to K times the voltage of Battery LV. (K=transformation ratio of the transformer=Np/Ns). In this step, the demagnetization circuit 304 is activated, the switch Mk remains in the on state (Mk=ON), and the converter tightens to recover the energy stored in the inductor L1. The controller 306 manages the commands of all the switches in order to regulate the load current of Chv and to ensure the current and voltage of all the components are not endangered, according to the timing diagram in FIG. 5. At the end of this first step, the switch Mk is deactivated (Mk=OFF).

For example, as illustrated in FIG. 5, the semiconductor switches M1 to M6 may switch from the on state to the off state at a frequency of several kilohertz. First M5, M1 and M4 are controlled in the on state (ON) the voltage across the transformer is positive, the current in the inductance L1 increases, its energy is transferred to the capacitor Chv. Then M5, M1 and M4 are controlled in the blocked state (OFF) and the current in the inductance L1 decreases, its energy is transferred to the capacitor Cdemag. Then M6, M2 and M3 are controlled in the on state (ON) the voltage at the terminals of the transformer goes negative, the current in the inductance L1 increases, its energy is transferred to the capacitor Chv. Then M6, M2 and M3 are controlled in the blocked state (OFF) and the current in the inductance L1 decreases, its energy is transferred to the capacitor Cdemag. During this step, the semiconductor switches MHdemag and MLdemag switch from the on state to the off state in opposition to a frequency of several kilohertz. The controller 306 is able to manage the commands and the times of the on state and the blocked state of the switches M1 to M6, MHdemag, and MLdemag in order to regulate the average current in the inductor L1 and to transfer the energy. In this manner, the power crossed by L1 and equal to the sum of the powers transferred to Chv and to Cdemag. Once the capacitor Chv has reached a voltage of K faith the voltage of the battery LV, the switch Mk is deactivated (OFF), the demagnetization circuit 304 is no longer useful the first step is finished.

For the transition between the end of stage 1 and the start of stage 2, which is the passage from Buck mode to Boost mode, the operations can be carried out according to the timing diagram in FIG. 6.

For example, referring to FIG. 6, when the voltage of capacitor Chv has reached the voltage of K×Vbattery LV, switch Mk goes to the locked state (OFF) to deactivate the demagnetization circuit 304 and the commands of the switches MHdemag and MLdemag remain in the locked state (OFF), which can be part of operation 420 of method 400. Then, for operation 430, the switches M1, M2, M3, M4, M5, and M6 start for stage 2 with a short-circuiting phase of the transformer (e.g., switches M5 and M6 at the on state (ON) and M1, M2, M3, and M4 in off state (OFF).

Returning to FIG. 4A, for boost mode between times tc1 and tc2 (stage 2), the voltage of the capacitor Chv is charged by K times the voltage of the LV battery 310 at the minimum input voltage of the converter 300. In this second step (e.g., operation 430) the capacitor Chv 308 is charged at the maximum input current of the converter 300.

For example, as illustrated in FIG. 6, the semiconductor switches M1 to M6 are switched from the on state to the off state at a frequency of several kilohertz. First M5 and M6 are controlled in the on state (ON), the current in the inductor L1 increases, thus L1 stores energy. Then, M5, M1 and M4 are controlled in the on state (ON) the voltage at the terminals of the transformer is positive, and the current in the inductor L1 decreases, its energy is transferred to the capacitor Chv. Then M5 and M6 are controlled in the on state (ON), the current in the inductor L1 increases, thus L1 stores energy. Then M6, M2 and M3 are controlled in the on state (ON) the voltage across the transformer is negative, and the current in the inductor L1 decreases, its energy is transferred to the capacitor Chv. While the capacitor Chv is charging, the controller 306 manages the commands and times of the on state and the off state of the switches M1 to M6 in order to regulate the charging current of the capacitor Chv at the maximum input current of the converter 300.

For boost mode in operation 440 between times tc2 and tc3 (stage 3), the capacitor voltage Chv 308 is charged from the minimum input voltage of the converter 300 to the HV battery voltage in order to connect the high voltage capacitor 308 to the high voltage network. In this third step the capacitor Chv 308 is charged to the maximum power of the converter 300. In this third step, the commands of the switches M1 to M6 are managed by the controller 306 with the same switch switching sequence as the previous step (stage 2; operation 430) as illustrated in FIG. 6, but the charge of the capacitor Chv is done at the maximum power of the converter 300.

As can be seen, while operating the DC-to-DC converter in the buck mode, the controller is structured to turn on a Mk switch of a demagnetization circuit coupled to an output inductor L1 of the DC-to-DC converter to activate the demagnetization circuit; and while operating the DC-to-DC converter in the first boost mode, the controller is structured to turn off the Mk switch, thereby deactivating the demagnetization circuit.

FIG. 7 shows a process flow diagram of example control logic for carrying out charging of the high voltage capacitor. As illustrated in FIG. 7, control logic 700 includes checking all the states of the voltages and currents of the converter (e.g., DC-to-DC converter circuit 302) and of the demagnetization circuit 304, activating or deactivating the demagnetization circuit 304, and organizing the regulation of the currents in order to respect the balance of transferred energies. “Energy crossed by L1=energy crossed by Ldemag+energy crossed by Chv”.

For good management of the charge of the capacitor Chv, the demagnetization circuit 304 is activated when the battery LV is present, the battery HV is disconnected, and the voltage of the capacitor Chv is lower than K times the battery voltage LV. The current in the inductor Ldemag is regulated so that “Energy crossed by L1=energy crossed by Ldemag+energy crossed by Chv” and that the voltage of the capacitor Cdemag does not exceed its maximum admissible value. Until the capacitor Chv is reached the value of K×the battery voltage LV. Thus, the first step, Buck Mode, is finished, and the Buck Mode is stopped by deactivating Mk, MHdemag and MLdemag (OFF) according to FIG. 6 (e.g., after the last activation of switches M6, M2, and M3). Then Boost Mode is activated, starting with activated M5, M6 (ON), and the charging currents of capacitor Chv and inductor L1 are monitored and regulated so as not to exceed the maximum current values admissible by the converter 300. Thus, this Boost mode charges the capacitor Chv up to the desired voltage HV (e.g., the voltage of the HV battery so that the battery can be connected).

Accordingly, an improvement of a DC-to-DC converter is described which transfers energy from a high voltage network to a low voltage network with galvanic isolation, which can be single-phase like shown in FIG. 3, multi-phase, a Push-pull, a phase-shifted bridge (FBPS), or any other similar structure, by adding a demagnetization circuit, which includes: a control circuit (e.g., controller) of the demagnetization circuit; a switch Mk which activates and deactivates the demagnetization circuit; and a demagnetization circuit consisting of a diode Ddemag, a demagnetization storage capacitor Cdemag, two switches MHdemag and MLdemag which are operated at a frequency of several kilohertz, and an Ldemag inductance which allows the transfer of energy to the low voltage network.

The above-described DC-to-DC converter can be used to charge the capacitors of a high voltage network from zero volts to a desired voltage, from the energy of a low voltage network. This can be accomplished without wasting energy stored in the output inductor L1 (see e.g., FIG. 3) of the converter by recovering the energy in a Cdemag capacitor and transferring this energy to the low voltage network.

A mechanical or semiconductor switch (Mk) can be used to connect and disconnect the demagnetization circuit, which aims to recover and transfer the stoker energy from the output inductor (L1) of the converter to a low voltage network.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

1. A method for charging a capacitor of a high voltage network from a low voltage power source using a DC-to-DC converter with an integrated capacitor charging function comprising a demagnetization circuit coupled to an output inductor L1 of the DC-to-DC converter and a controller, the method comprising:
operating, by the controller, the DC-to-DC converter in a buck mode while the demagnetization circuit is enabled;
switching, by the controller, from the buck mode to a first boost mode;
operating, by the controller, the DC-to-DC converter in the first boost mode, wherein during the first boost mode, the capacitor of the high voltage network is charged at a maximum input current and the demagnetization circuit is disabled; and
operating, by the controller, the DC-to-DC converter in a second boost mode, wherein during the second boost mode, the capacitor of the high voltage network is charged to a maximum power of the converter until a voltage of the high voltage network is achieved.

2. The method of claim 1, further comprising, coupling a high voltage battery to the high voltage network after the voltage of the high voltage network is achieved.

3. The method of claim 1, wherein the DC-to-DC converter comprises a half bridge full bridge converter.

4. The method of claim 1, wherein the DC-to-DC converter comprises a phase shift converter.

5. The method of claim 1, wherein the DC-to-DC converter comprises a push-pull converter.

6. The method of claim 1, wherein the demagnetization circuit comprises a demagnetization capacitor Cdemag, a demagnetization inductor Ldemag, a demagnetization diode Ddemag, and switches Mk, MHdemag, and MLdemag,
wherein the Ldemag is coupled at a first end to a first node at a first end of L1, which is coupled to a positive line of a low voltage capacitor and coupled at a second end to a second node,
wherein the MLdemag is coupled at its drain to the second node at the second end of the Ldemag and is coupled at its source to a ground line of the low voltage capacitor,
wherein the Ddemag is coupled at one end to a second end of L1 and is coupled at another end to a third node coupled to a first end of the Cdemag,
wherein the MHdemag is coupled at its source to the second node at the second end of the Ldemag and is coupled at its source to the third node coupled to the first end of the Cdemag, and
wherein the Mk switch is coupled at its drain to a second end of the Cdemag and is coupled at its source to the ground line of the low voltage capacitor.

7. The method of claim 6, wherein while operating the DC-to-DC converter in the buck mode, the method comprises turning on the Mk switch to enable the demagnetization circuit.

8. The method of claim 6, wherein while operating the DC-to-DC converter in the first boost mode, the method comprises turning off the Mk switch to disable the demagnetization circuit.

9. A DC-to-DC converter with an integrated capacitor charging function, the DC-to-DC converter comprising:
a demagnetization circuit coupled to an output inductor L1 of the DC-to-DC converter.

10. The DC-to-DC converter of claim 9, wherein the DC-to-DC converter comprises a half bridge full bridge converter.

11. The DC-to-DC converter of claim 9, wherein the DC-to-DC converter comprises a phase shift converter.

12. The DC-to-DC converter of claim 9, wherein the DC-to-DC converter comprises a push-pull converter.

13. The DC-to-DC converter of claim 9, wherein the demagnetization circuit comprises a demagnetization capacitor Cdemag, a demagnetization inductor Ldemag, a demagnetization diode Ddemag, and switches Mk, MHdemag, and MLdemag,
wherein the Ldemag is coupled at a first end to a first node at a first end of L1, which is coupled to a positive line of a low voltage capacitor and coupled at a second end to a second node,
wherein the MLdemag is coupled at its drain to the second node at the second end of the Ldemag and is coupled at its source to a ground line of the low voltage capacitor,
wherein the Ddemag is coupled at one end to a second end of L1 and is coupled at another end to a third node coupled to a first end of the Cdemag,
wherein the MHdemag is coupled at its source to the second node at the second end of the Ldemag and is coupled at its source to the third node coupled to the first end of Cdemag, and
wherein the Mk switch is coupled at its drain to a second end of the Cdemag and is coupled at its source to the ground line of the low voltage capacitor.

14. A controller for charging a capacitor of a high voltage network from a low voltage power source using a DC-to-DC converter with an integrated capacitor charging function, the controller structured to:
operate the DC-to-DC converter in a buck mode while a demagnetization circuit coupled to an output inductor L1 of the DC-to-DC converter is enabled;
switch from the buck mode to a first boost mode;
operate the DC-to-DC converter in the first boost mode, wherein during the first boost mode, the capacitor of the high voltage network is charged to a maximum input current and the demagnetization circuit is disabled; and
operate the DC-to-DC converter in a second boost mode, wherein during the second boost mode, the capacitor of the high voltage network is charged to a maximum power of the converter until a voltage of the high voltage network is achieved.

15. The controller of claim 14, wherein while operating the DC-to-DC converter in the buck mode, the controller is structured to turn on a Mk switch of the demagnetization circuit to activate the demagnetization circuit; and while operating the DC-to-DC converter in the first boost mode, the controller is structured to turn off the Mk switch, thereby deactivating the demagnetization circuit.
